(19) United States
(12) Patent Application Publication
(10) Pub. No.: US 2015/0118665 A1
(43) Pub. Date: Apr. 30, 2015

(54) SYSTEM AND METHOD FOR ANTICIPATING ACTIVITY

(71) Applicant: JayBird LLC, Salt Lake City, UT (US)

(72) Inventor: Judd Armstrong, Parrearra (AU)

(73) Assignee: JAYBIRD LLC, Salt Lake City, UT (US)

(21) Appl. No.: 14/221,065

(22) Filed: Mar. 20, 2014

Related U.S. Application Data
(63) Continuation-in-part of application No. 14/140,414, filed on Dec. 24, 2013.
Application No. 14/140,414 is a continuation-in-part of application No. 14/137,942, filed on Dec. 20, 2013.
Application No. 14/137,942 is a continuation-in-part of application No. 14/137,734, filed on Dec. 20, 2013.
Application No. 14/137,734 is a continuation-in-part of application No. 14/062,815, filed on Oct. 24, 2013.

(51) Int. Cl. G09B 19/00

(52) U.S. Cl. CPC G09B 19/00
USPC 434/236

(57) ABSTRACT

A system for anticipating activity includes an apparatus for anticipating activity. The apparatus includes an activity anticipation module that anticipates an activity based on an archive. The archive includes historical information associated with past activity. The apparatus also includes an encouragement module that provides encouragement for the activity. The encouragement is based on the archive and the activity.

### CROSS REFERENCE TO RELATED APPLICATIONS

This application is a continuation-in-part of and claims the benefit of U.S. patent application Ser. No. 14/140,414, filed Dec. 24, 2013, titled “System and Method for Providing Intelligent Goal Recommendation for Activity Level,” which is a continuation-in-part of U.S. patent application Ser. No. 14/137,942, filed Dec. 20, 2013, titled “System and Method for Providing an Interpreted Recovery Score,” which is a continuation-in-part of U.S. patent application Ser. No. 14/137,734, filed Dec. 20, 2013, titled “System and Method for Providing a Smart Activity Score,” which is a continuation-in-part of U.S. patent application Ser. No. 14/062,815, filed Oct. 24, 2013, titled “Wristband with Removable Activity Monitoring Device.” The contents of the Ser. No. 14/140,414 application, Ser. No. 14/137,942 application, the Ser. No. 14/137,734 application, and the Ser. No. 14/062,815 application are incorporated herein by reference.

### TECHNICAL FIELD

The present disclosure relates generally to activity tracking and activity anticipation devices, and more particularly to a system and method for anticipating activity.

### DESCRIPTION OF THE RELATED ART

Previous generation activity tracking devices generally did not anticipate activity. Currently available activity anticipation devices now add functionality that anticipates activities entered into a calendar. One issue is that currently available activity anticipation devices do not anticipate activity based on past performance. Another issue is that currently available solutions do not provide encouragement, notifications, or target goals for the activity that are tailored specifically to a user's measured performance.

### BRIEF SUMMARY OF THE DISCLOSURE

In view of the above drawbacks, there exists a long-felt need for activity tracking and anticipation devices that anticipate a user's activity based on the user's past performance. Further, there is a need for activity tracking and anticipation devices that provide encouragement, notifications, and target goals for the activity, and that tailor the encouragement, notifications, and target goals specifically to the user's measured performance characteristics. Moreover, there is a long-felt need for activity tracking and anticipation devices that utilize device connectivity and social media.

Embodiments of the present disclosure include systems and methods for anticipating activity.

One embodiment of the disclosure includes an apparatus for anticipating activity. The apparatus includes an activity anticipation module that anticipates an activity based on an archive. The archive includes historical information associated with past activity. The apparatus also includes an encouragement module that provides encouragement for the activity. The encouragement is based on the archive and the activity. The encouragement, in one embodiment, includes media content. In a further embodiment, the media content is selected based on the archive indicating an association between the media content and the activity.

The apparatus for anticipating activity, in one case, includes a notification module that provides a notification associated with the activity. In one instance, the notification module provides the notification via social media. In another instance, the notification module provides the notification to an electronic device. The apparatus, in another case, includes a target goal module that provides a set of target goals for the activity. Each target goal is based on the archive and the activity. The set of target goals, in one embodiment, includes at least one of a target activity type, a target activity intensity, and a target activity duration. In various embodiments, at least one of the activity anticipation module and the encouragement module is embodied in a wearable sensor.

One embodiment of the present disclosure involves a method for anticipating activity. The method includes anticipating an activity based on an archive. The archive includes historical information associated with past activity. The method also includes providing encouragement for the activity. The encouragement is based on the archive and the activity. The encouragement, in one embodiment, includes media content. The media content, in one instance, includes a set of songs. In a further embodiment, the media content is selected based on the archive indicating an association between the media content and the activity.

The method for anticipating activity, in one case, includes providing a providing a notification associated with the activity. In one instance, the notification is provided via social media. In another instance, the notification is provided to an electronic device. The method, in another case, includes providing a set of target goals for the activity. Each target goal is based on the archive and the activity. The set of target goals, in one embodiment, includes at least one of a target activity type, a target activity intensity, and a target activity duration. In various embodiments, at least one of the operations of anticipating the activity and providing encouragement for the activity includes using a sensor configured to be attached to the body of the user.

One embodiment of the disclosure includes a system for anticipating activity. The system includes a processor and at least one computer program residing on the processor. The computer program is stored on a non-transitory computer readable medium having computer executable program code embodied thereon. The computer executable program code is configured to anticipate an activity based on an archive. The archive includes historical information associated with past activity. The computer executable program code is also configured to provide encouragement for the activity. The encouragement is based on the archive and the activity.

Other features and aspects of the disclosure will become apparent from the following detailed description, taken in conjunction with the accompanying drawings, which illustrate, by way of example, the features in accordance with embodiments of the disclosure. The summary is not intended to limit the scope of the disclosure, which is defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments of the disclosure.

FIG. 1 illustrates a cross-sectional view of a wristband and electronic modules of an example activity anticipation device.

FIG. 2 illustrates a perspective view of an example activity anticipation device.

FIG. 3 illustrates a cross-sectional view of an example assembled activity anticipation device.

FIG. 4 illustrates a side view of an example electronic capsule.

FIG. 5 illustrates a cross-sectional view of an example electronic capsule.

FIG. 6 illustrates perspective views of wristbands as used in one embodiment of the disclosed activity anticipation device.

FIG. 7 illustrates an example system for anticipating activity.

FIG. 8 illustrates an example apparatus for anticipating activity.

FIG. 9 illustrates another example apparatus for anticipating activity.

FIG. 10A is an operational flow diagram illustrating an example method for anticipating activity.

FIG. 10B is an example of an archive table.

FIG. 11 is an operational flow diagram illustrating an example method for anticipating activity including providing a notification.

FIG. 12 illustrates an example computing module that may be used to implement various features of the systems and methods disclosed herein.

The figures are not intended to be exhaustive or to limit the disclosure to the precise form disclosed. It should be understood that the disclosure can be practiced with modification and alteration, and that the disclosure can be limited only by the claims and the equivalents thereof.

### DETAILED DESCRIPTION

The present disclosure is directed toward systems and methods for anticipating activity. The disclosure is directed toward various embodiments of such systems and methods. In one such embodiment, the systems and methods are directed to a device for anticipating activity. According to some embodiments of the disclosure, the device may be an electronic capsule embedded in and removable from an attachable device that may be attached to a user. In one embodiment, the attachable device is a wristband. In another embodiment, the attachable device includes an activity monitoring device. In various embodiments, the device may be embedded in electronics, such as in a tablet computer, smartphone, and the like.

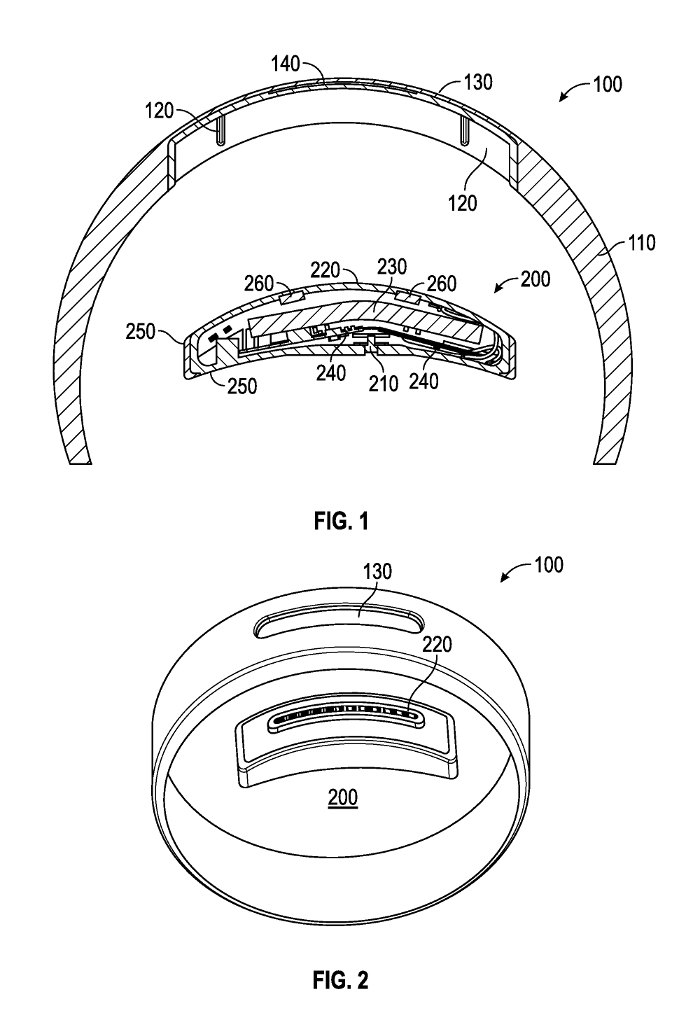

FIG. 1 is a diagram illustrating a cross-sectional view of an example embodiment of an activity anticipation device. Referring now to FIG. 1, an activity anticipation device includes electronic capsule 200 and wristband 100. Electronic capsule 200 includes wrist biosensor 210, finger biosensor 220, battery 230, one or more logic circuits 240, and casing 250.

In some embodiments, logic circuits 240 include an accelerometer, a wireless transmitter, a wireless receiver, and circuitry. Logic circuits 240 may further include a gyroscope. Logic circuits 240 may be configured to process electronic input signals from biosensors 210, 220 and the accelerometer, store the processed signals as data, and output the data using the wireless transmitter. The transmitter is configured to communicate using available wireless communications standards (e.g., over communication medium 704). For example, in some embodiments, the wireless transmitter is a BLUETOOTH transmitter, a Wi-Fi transmitter, a GPS transmitter, a cellular transmitter, or a combination thereof. In an alternative embodiment, the wireless transmitter further includes a wired interface (e.g. USB, fiber optic, HDMI, etc.) for communicating stored data.

Logic circuits 240 are electrically coupled to wrist biosensor 210 and finger biosensor 220. In addition, logic circuits 240 are configured to receive and process a plurality of electric signals from each of wrist biosensor 210 and finger biosensor 220. In some embodiments, the plurality of electric signals includes an activation time signal and a recovery time signal such that logic circuits 240 process the plurality of signals to calculate an activation recovery interval equal to the difference between the activation time signal and the recovery time signal. In some embodiments, the plurality of signals includes electro-cardio signals from a heart, and logic circuits 240 process the electro-cardio signals to calculate and store a RR-interval, and the RR-interval is used to calculate and store a heart rate variability (HRV) value. In such embodiments, the RR-interval is equal to the delta in time between two R-waves, where the R-waves are the electro-cardio signals generated by a ventricle contraction in the heart.

In some embodiments, logic circuits 240 further detect and store metrics such as the amount of physical activity, duration and quality of sleep or rest over a recent period of time, and the amount of time without physical activity over a recent period of time. Logic circuits 240 may then use the HRV, or the HRV in combination with these metrics, to calculate a fatigue level. For example, logic circuits 240 may detect the amount of physical activity and the amount of sleep a user experienced over the last 48 hours, combine those metrics with the user's HRV, and calculate a fatigue level of between 1 and 10. In such an example, the fatigue level may indicate the user's physical condition and aptitude for further physical activity that day. The fatigue level may also be represented on a descriptive scale—for example, low, normal, and high.

Finger biosensor 220 and wrist biosensor 210, in some embodiments, are replaced or supplemented by a single biosensor. In one such embodiment, the single biosensor is an optical biosensor, such as a pulse oximeter, configured to detect blood oxygen saturation levels. The pulse oximeter may output a signal to logic circuits 240 indicating a detected cardiac cycle phase, and logic circuits 240 may use cardiac cycle phase data to calculate an HRV value.

Wristband 100 includes material 110 configured to encircle a human wrist. In one embodiment, wristband 100 is adjustable. Cavity 120 is notched on the radially inward facing side of wristband 100 and is shaped to substantially the same dimensions as the profile of electronic capsule 200. In addition, aperture 130 is located in material 110 within cavity 120. Aperture 130 is shaped to substantially the same dimensions as the profile of finger biosensor 220. The combination of cavity 120 and aperture 130 is designed to detachably couple to electronic capsule 200 such that, when electronic capsule 200 is positioned inside cavity 120, finger biosensor 220 protrudes through aperture 130. Electronic capsule 200 may further include one or more magnets 260 configured to secure electronic capsule 200 to cavity 120. Magnets 260 may be concealed in casing 250. Cavity 120 may be configured to conceal magnets 260 when electronic capsule 200 detachably couples to the combination of cavity 120 and aperture 130.

Wristband 100 may further include steel strip 140 concealed in material 110, within cavity 120. In this embodiment, when electronic capsule 200 is positioned within cavity 120, one or more magnets 260 are attracted to steel strip 140 and pull electronic capsule 200 radially outward with respect to wristband 100. The force provided by magnets 260 may detachably secure electronic capsule 200 inside cavity 120. In further embodiments, electronic capsule 200 is positioned inside cavity 120 and affixed using a form-fit, press-fit, snap-fit, friction-fit, VELCRO, or other temporary adhesion or attachment technology.

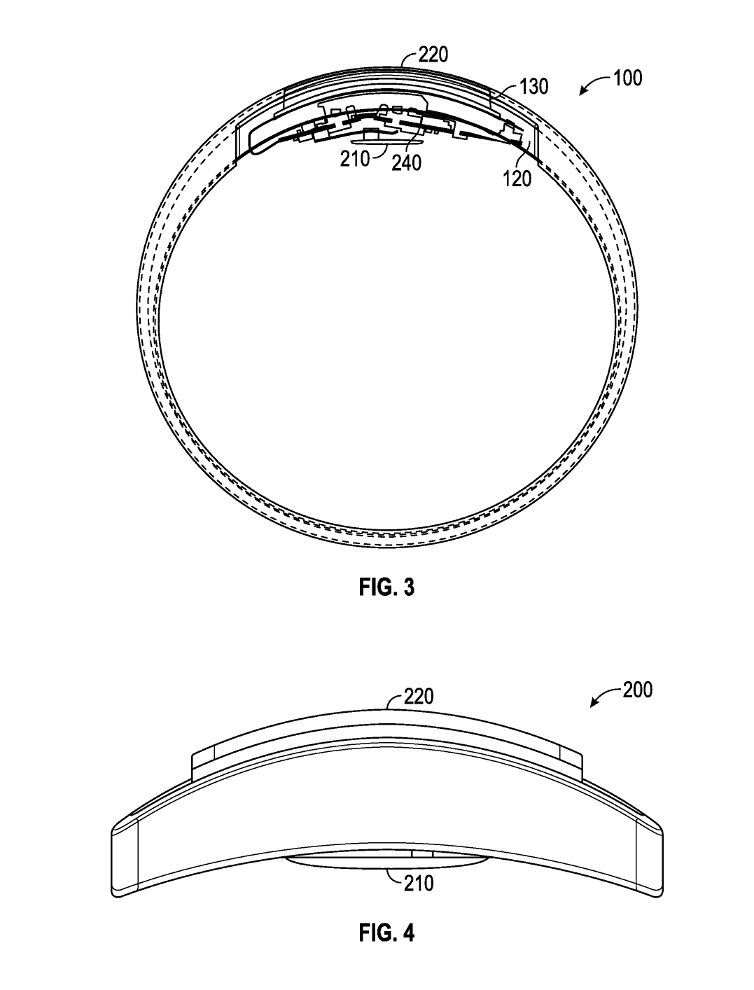

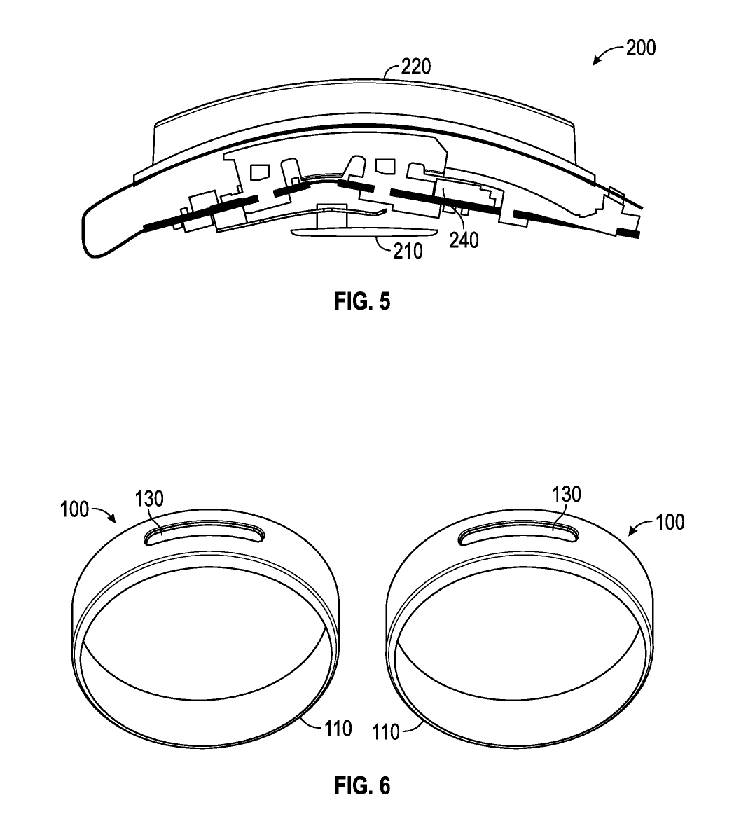

FIG. 2 illustrates a perspective view of one embodiment of the disclosed device for anticipating activity, in which wristband 100 and electronic capsule 200 are unassembled. FIG. 3 illustrates a cross-sectional view of one embodiment of a fully assembled wristband 100 with removable device for anticipating activity. FIG. 4 illustrates a side view of electronic capsule 200 according to one embodiment of the disclosure. FIG. 5 illustrates a cross-sectional view of electronic capsule 200. FIG. 6 is a perspective view of two possible variants of wristband 100 according to some embodiments of the disclosure. Wristbands 100 may be constructed with different dimensions, including different diameters, widths, and thicknesses, in order to accommodate different human wrist sizes and different preferences. Moreover, wristband 100 may be constructed to be streamlined to the user's wrist, such that wristband 100 is comfortable to wear during sleep and various activities.

In one embodiment of the disclosure, electronic capsule 200 includes an optical sensor, such as a heart rate sensor or oximeter. In this embodiment, the optical sensor is positioned to face radially inward toward a human wrist when wristband 100 is fit on the wrist. The optical sensor, in another example, is separate from electronic capsule 200, but is still detachably coupled to wristband 100 and electronically coupled to the circuit boards enclosed in electronic capsule 200. Wristband 100 and electronic capsule 200 may operate in conjunction with a system for anticipating activity.

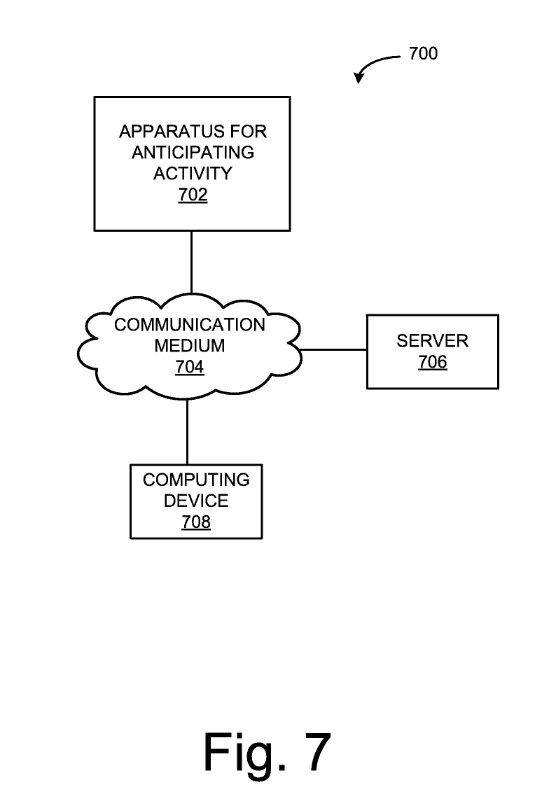

FIG. 7 is a schematic block diagram illustrating example system 700 for anticipating activity. System 700 includes apparatus for anticipating activity 702, communication medium 704, server 706, and computing device 708.

Communication medium 704 may be implemented in a variety of forms. For example, communication medium 704 may be an Internet connection, such as a local area network (“LAN”), a wide area network (“WAN”), a fiber optic network, internet over power lines, a hard-wired connection (e.g., a bus), and the like, or any other kind of network connection or series of network connections. Communication medium 704 may be implemented using any combination of routers, cables, modems, switches, fiber optics, wires, radio, and the like. Communication medium 704 may be implemented using various wireless standards, such as Bluetooth, Wi-Fi, 4G LTE, etc. One of skill in the art will recognize other ways to implement communication medium 704 for communications purposes.

Server 706 directs communications made over communication medium 704. Server 706 may be, for example, an Internet server, a router, a desktop or laptop computer, a smartphone, a tablet, a processor, a module, or the like. In one embodiment, server 706 directs communications between communication medium 704 and computing device 708. For example, server 706 may update information stored on computing device 708, or server 706 may send information to computing device 708 in real time.

Computing device 708 may take a variety of forms, such as a desktop or laptop computer, a smartphone, a tablet, a processor, a module, or the like. In addition, computing device 708 may be a processor or module embedded in a wearable sensor, a bracelet, a smart-watch, a piece of clothing, an accessory, and so on. For example, computing device 708 may be substantially similar to devices embedded in electronic capsule 200, which may be embedded in and removable from wristband 100, as illustrated in FIG. 1. Computing device 708 may communicate with other devices over communication medium 704 with or without the use of server 706. In one embodiment, computing device 708 includes apparatus 702. In various embodiments, apparatus 702 may be used to perform various processes described herein.

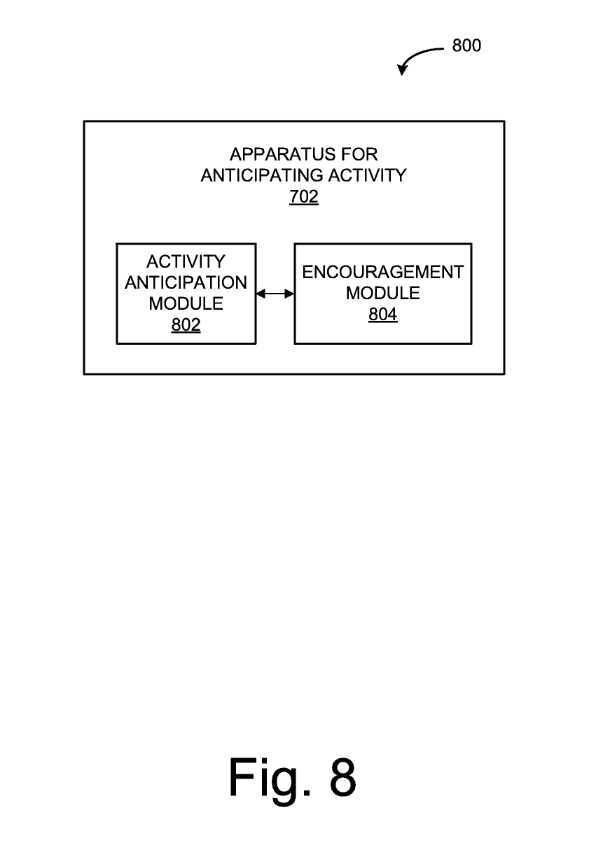

FIG. 8 is a schematic block diagram illustrating one embodiment of apparatus for anticipating activity 800. Apparatus 800 includes apparatus 702 with activity anticipation module 802 and encouragement module 804.

Activity anticipation module 802 anticipates an activity based on an archive. The archive includes historical information associated with past activity. Activity anticipation module 802 will be described below in further detail with regard to various processes.

Encouragement module 804 provides encouragement for the activity. The encouragement is based on the archive and the activity. Encouragement module 804 will be described below in further detail with regard to various processes.

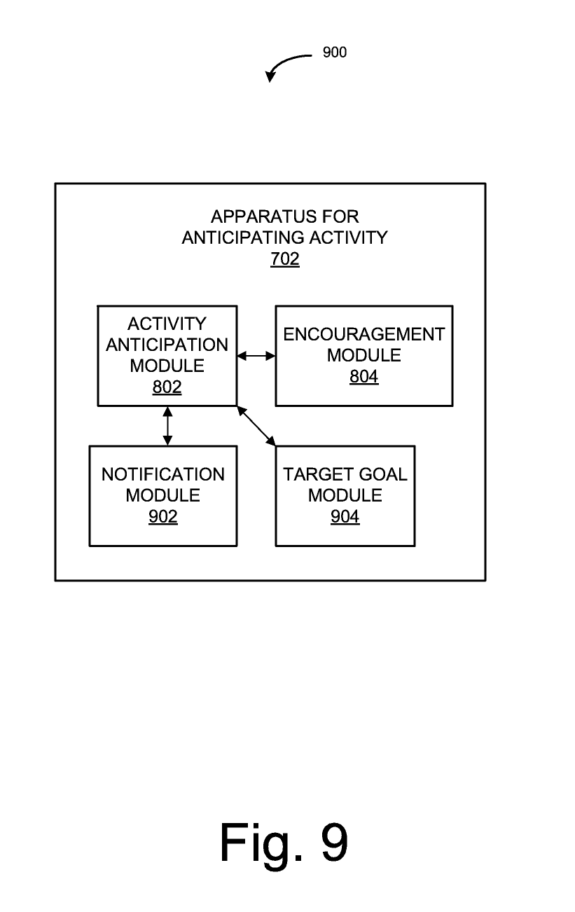

FIG. 9 is a schematic block diagram illustrating one embodiment of apparatus for anticipating activity 900. Apparatus 900 includes apparatus 702 with activity anticipation module 802 and encouragement module 804. Apparatus 900 also includes notification module 902 that provides a notification associated with the activity. In addition, apparatus 900 includes target goal module 904 that provides a set of target goals for the activity. Each target goal is based on the archive and the activity. Notification module 902 and target goal module 904 will be described below in further detail with regard to various processes.

In one embodiment, at least one of activity anticipation module 802, encouragement module 804, notification module 902, and target goal module 904 is embodied in a wearable sensor, such as electronic capsule 200. In various embodiments, any of the modules described herein are embodied in electronic capsule 200, or in an electronic device (e.g., computing device 708), and connect to other modules described herein via communication medium 704.

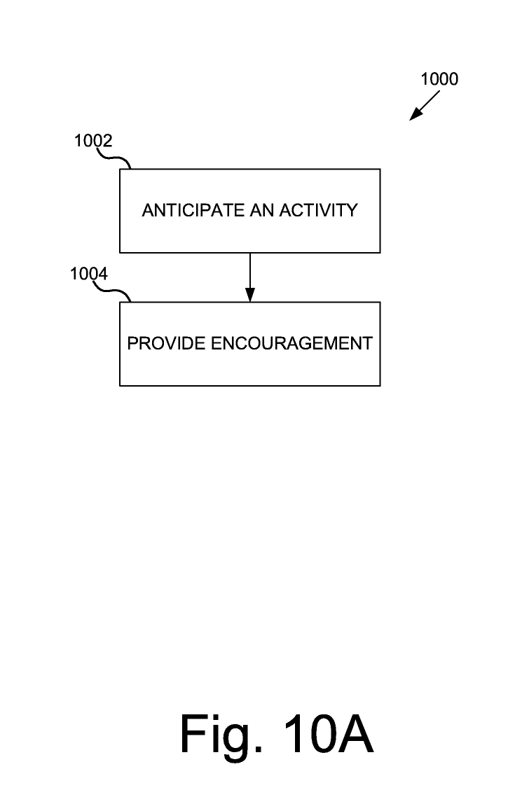

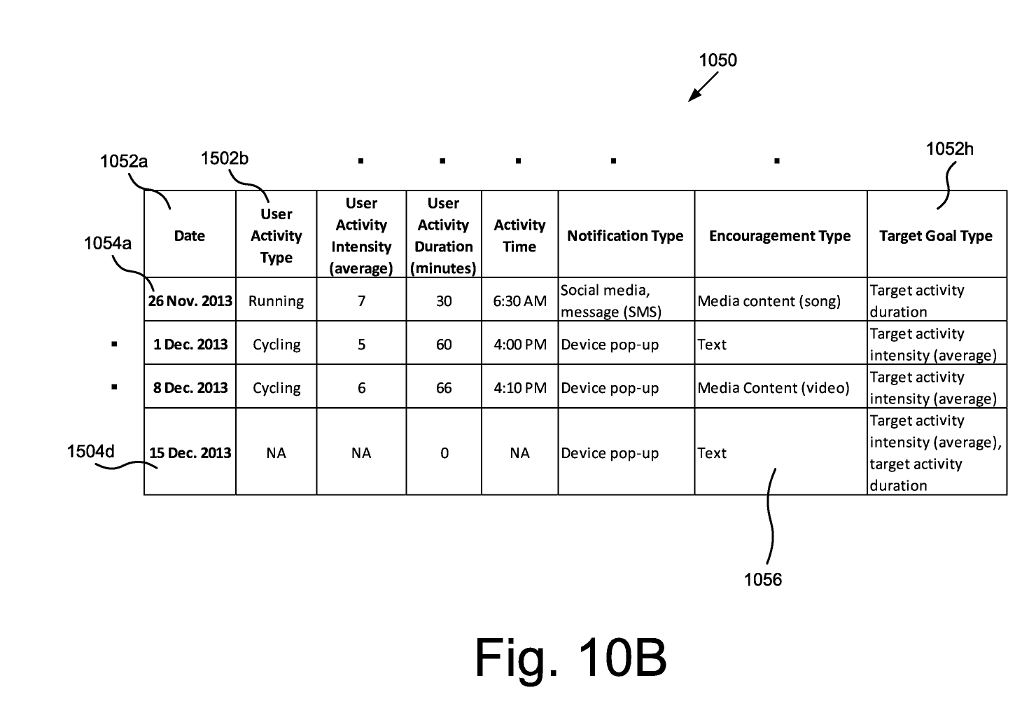

FIG. 10A is an operational flow diagram illustrating example method 1000 for anticipating activity in accordance with an embodiment of the present disclosure. The operations of method 1000 anticipate an activity and provide encouragement that is tuned specifically to a user's past performance achievements that are associated with the activity. This aids in providing encouragement that is specifically tailored to the user and that helps the user achieve peak performance in the users' activities. In one embodiment, apparatus 702, wristband 100, and electronic capsule 200 perform various operations of method 1000.

One embodiment of method 1000 includes monitoring a movement to identify a user activity type from a set of reference activity types, a user activity intensity from a set of reference activity intensities, and an activity duration for the user activity type or the user activity intensity. Examples of reference activity types include activities such as running, walking, sleeping, swimming, bicycling, skiing, surfing, resting, working, and so on.

The reference activity intensities may be represented in various forms. By way of example, the reference activity intensities may include a numeric scale, and may be associated with the vigorousness of the user's activity. The user activity intensity, in one embodiment, is an average user intensity for a particular user activity type.

The activity duration may be an elapsed time during which the user participated in the user activity type. In addition, the activity duration may be an elapsed time during which the user participated in the user activity at a particular user activity intensity. In various embodiment, the user activity type, user activity intensity, and activity duration are determined using an accelerometer, gyroscope, and other sensors (e.g., a heart-rate monitor).

At operation 1002, method 1000 includes anticipating an activity based on an archive. The archive includes historical information associated with past activity. For example, the archive may include information about the timing of the past activity—e.g., time and date information of the activity. In one embodiment, the archive includes historical information about the movement that occurred during the past activity. For example, the archive may include historical information about past user activity types, past user activity intensities, and past activity durations.

The archive, in another embodiment, includes historical information about past fatigue levels and past activity locations, as well as information about persons with whom the past activity was performed. Further, the archive may include historical information about the user's mood or general overall feeling, either mental or physical, before, during, or after the past activity. In one embodiment, the archive includes historical information about notifications associated with the past activity, including notification type and notification content. Moreover, the archive may include information and about encouragement, including type and content, associated with the past activity.

In various embodiments, the archive is implemented as a table or series of tables, and contains any number of additional information categories, for example, social media events and responses associated with the activity, past and predicted weather conditions, and so on. FIG. 10B illustrates an example embodiment of an archive, including archive table 1050. Archive table 1050 contains archive rows 1054a-d and archive columns 1052a-h. Each archive row 1054 and archive column 1052 combination includes archive data, for example, archive data 1056. Archive table 1050 may contain additional or different archive rows 1054 or archive columns 1052 than illustrated in FIG. 10B. The archive, in various embodiments, is embedded in apparatus 702 or computing device 708.

Referring again to operation 1002, anticipating the activity based on the archive may be based on any of the information in the archive. For example, the activity may be anticipated based on timing and date information about past activity. To illustrate, the information may indicate that the user consistently goes running at 6:30 AM each Tuesday morning. Upcoming activity may be anticipated based on the assumption that the user will continue—or desires to continue—the status quo. In this example, the status quo would include going running each Tuesday at 6:30 AM. In one embodiment, the anticipated activity is a specific activity—for example, running. In other embodiments, the anticipated is general—for example, exercise, rest, work, and so on.

The activity, in one embodiment, is anticipated even absent a consistent track record of performance. By way of example, the user may have only participated in the activity one time, but such an activity may still be anticipated to recur periodically at various periods. The activity, in another embodiment, is anticipated even though the user never performed the activity. To illustrate, the user may have an activity calendared (e.g., the user is scheduled to go running each Tuesday at 6:30 AM), but the user may fail to go running several Tuesday mornings. In such an embodiment, the activity is anticipated based on the user's calendar, even though the user did not actually go running on Tuesday at 6:30 AM. In a further example, the activity is anticipated based on various inputs—e.g., from the user or from another source.

Referring again to FIG. 10A, at operation 1004, method 1000 involves providing encouragement for the activity. The encouragement is based on the archive and the activity. In general, the encouragement may motivate the user to excel in the activity or do take certain actions related to the activity. The encouragement may take various forms and may be provided before, during, or after the activity. In one embodiment, the encouragement is a communication to the user. For example, the encouragement may be a message (e.g., text or audio) to the user telling the user to keep up the good work. The encouragement, in another embodiment, is provided visually. In such an embodiment, the encouragement may be in the form of a ghost comparison. For example, if the activity is running, the encouragement may visually compare the user's current running performance to a past running performance. This may be in the form of providing a graphical comparison of progress through a route, average rate of speed, calories burned, and so on.

In another embodiment, the encouragement includes media content. The media content may include, for example, a video, photo, or text displayed on an electronic device. In one instance, the media content includes one or more songs, or a playlist of songs. The media content, in one embodiment, is selected based on the archive indicating an association between media content and the activity. Such an association may be stored in the archive. For example, the user may have a playlist that the user created specifically for going running. The playlist may be specifically designated as a running playlist, or the archive may have information indicating that the user frequently listens to the playlist when the user goes running. In one embodiment, upon anticipating the activity (at operation 1002), the media content associated with that activity is provided.

The media content associated with the activity, in one embodiment, is determined to be the user's favorite media content for the activity. For example, the archive may indicate that the user runs faster when listening to a particular song, or the archive may indicate that the user runs for longer when listening to a particular playlist. In addition, the archive may indicate that the user always goes running when a particular video or song is played, but does not always go running when the video or song is not played. In a further embodiment, the user designates that particular media content is the user's favorite. In such cases, the encouragement provided includes the user's favorite media content associated with the anticipated activity. This may aid the user in performing the activity at a higher level and may help motivate the user to undertake the activity in the first place.

In various embodiments, the media content may be selected based on the user's online browsing activity. Such online browsing activity may be related to various mobile applications or Internet applications. For example, the media content may be selected based on the user's activity on Facebook®, Pandora®, SoundCloud®, YouTube®, and so on. The media content may be provided via communication medium 704.

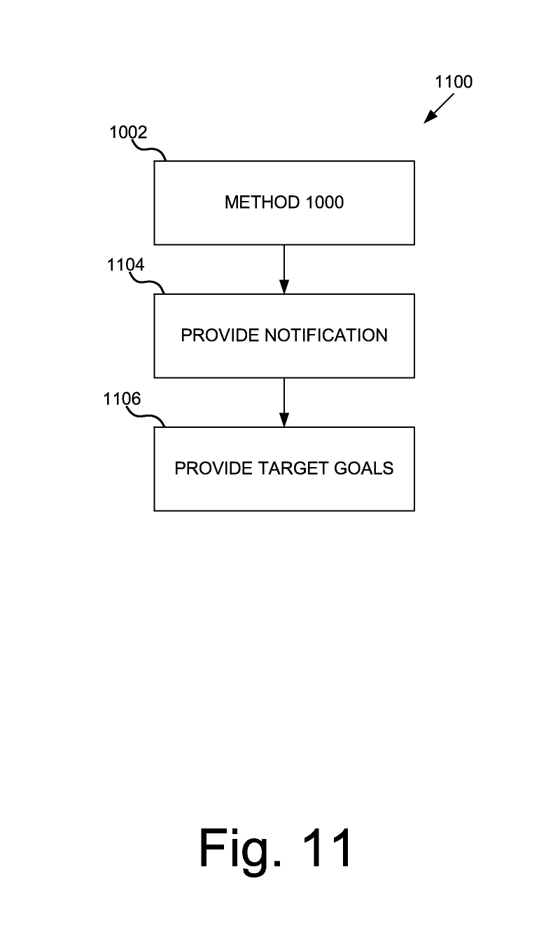

FIG. 11 is an operational flow diagram illustrating example method 1100 for anticipating activity. In various embodiments, the operations of method 1100 provide a notification associated with the activity and provide a set of target goals for the activity. The notification and the target goals may help motivate the user, and may also help push the user to achieve higher performance. Increased effectiveness may be achieved as both the notification and the target goals are specifically tailored to the user. In one embodiment, apparatus 702, wristband 100, and electronic capsule 200 perform various operations of method 1100. Method 1100, in various embodiments, includes one or more operations of method 1000, represented at operation 1102.

At operation 1104, one embodiment of method 1100 includes providing a notification associated with the activity. The notification may include information associated with the activity. For example, if there is an anticipated activity type, duration, location, or the like, the notification may indicate such information. In one embodiment, the notification is delivered to an electronic device, which may include a smartphone, television, tablet, smartwatch, computer, or other device. The notification may be in the form of a text message, a pop-up window, an alert, and so on. The notification, in one embodiment, is provided before the time at which the activity is anticipated to take place. For example, the activity may be anticipated to take place at 6:30 AM, and the notification may be provided at 8:30 PM the evening before.

In one embodiment, the notification is provided at a programmable amount of time before the activity. For example, the user may program the notification to be provided two hours before the anticipated activity. The notification, in another embodiment, is provided at an amount of time before the activity that is based on the activity. For example, if the activity is swimming, the user may require sufficient time to get to the location of the pool, change clothes, stretch, etc. This time may be taken into account such that the notification is provided far enough in advance that the user may prepare for the activity and complete the activity during the desired or allotted time. In one embodiment, the notification has a built in snooze function.

The notification, in another embodiment, is provided via social media. For example, the notification may take the form of a post or status update on Facebook® or a Tweet on Twitter®, or the like. Providing the notification via social media may create accountability for the user in performing the activity. This is because the user may likely have an increased desire to undertake the activity when the user's friends and other connections (or the general public, as the case may be) become aware that the activity is anticipated. Moreover, providing the notification via social media may result in the user receiving encouragement from the user's friends and other connections. For example, upon viewing the notification, the user's social media friends and connections may comment on or otherwise respond to the notification to provide encouragement.

Additionally, providing the notification via social media may allow the user's friends and connections to join the user in the activity, to comment on conditions related to the activity (e.g., weather, road, etc.), or to provide other input. In one embodiment, social media connections who respond to the notification via social media are given the option to directly receive (e.g., via social media, electronic device, etc.) subsequent notifications related to the user's activity. The user may have the ability to select which social media connections are able to receive notifications directly.

In one embodiment, the notification is based on the archive. In such an embodiment, the archive, by way of the historical information accessible to the archive, learns the most effective forms of notification for the user. For example, the information may indicate that the user often performs the activity when the notification is posted on the user's Facebook® page. Or, for example, the information may indicate that the user often performs the activity when the notification is delivered to the user's smartphone via text message, but not when the notification is delivered via email. Similarly, in other embodiments, the information indicates that particular notification content is most effective for the user. For example, the user may respond better to a message calling the user lazy than to a message simply telling the user to undertake the activity. In this manner, the notification may be tailored to the user's preferences and may provide a targeted, effective notification.

Referring again to FIG. 11, at operation 1106, one embodiment of method 1100 includes providing a set of target goals for the activity. Each of the target goals is based on the archive and the activity. The target goals may include any type of goal associated with the activity and may vary depending on the nature of the activity that is anticipated. For example, the target goal may be that the user participate in the activity with a particular person (e.g., one of the user's friends) or a pet, that the user feel a particular way during or after the activity, or that the user undertake the activity at a particular location (target location). As an example of the target goal varying as a function of the activity, the target location for running may be different than the target location for cycling. Being based on the archive, the target goals may be tailored to the user, and may facilitate pushing the user beyond the user's previous performance.

The set of target goals, in one embodiment, includes at least one of a target activity type, a target activity intensity, a target activity distance, and a target activity duration. When a target goal is a target activity type, the user may achieve the target goal by performing the activity type. Likewise with the target activity intensity, target activity distance, and the target activity duration.

For example, the archive may indicate that the user exercised for an activity duration of thirty minutes for the user's previous workout. To facilitate performance improvement and to push the user, the target goal may include a target activity duration of thirty-five minutes for the user's anticipated workout, thus extending the activity duration to push the user. As an additional example, the archive may indicate that the user completed a 5-mile run at an average user activity intensity of 7.0. The target goal may include an increased target activity intensity of 7.5 for a subsequent run, pushing to user to improve.

In one embodiment, the set of target goals includes a combination of a target activity type, target activity intensity, target activity distance, and target activity duration. For example, the set of target goals may include that the user run for forty-five minutes at high intensity. The set of target goals in another embodiment, includes multiple target activity types, with each target activity type having an associated target activity intensity and an associated target activity duration. This may facilitate cross-training.

The target goals, in one embodiment, are based on the user's fatigue level. For example, a higher fatigue level may correspond to a lower target activity intensity or a lower target activity duration, while a lower fatigue level may correspond to a higher target activity intensity or a higher target activity duration. The fatigue level may be detected in various ways. The fatigue level, in one example, is detected by measuring a heart rate variability (HRV) of the user using logic circuits 240 (discussed above in reference to FIG. 1). When the HRV is more consistent (i.e., steady, consistent amount of time between heartbeats) the fatigue level may be higher. When HRV is more sporadic (i.e., amount of time between heartbeats varies), the fatigue level may be lower. In general, with a lower fatigue level, the body is more fresh and well-rested.

HRV may be measured in a number of ways (discussed above in reference to FIG. 1). Measuring HRV, in one embodiment, involves the combination of wrist biosensor 210 and finger biosensor 220. Wrist biosensor 210 may measure the heartbeat in the wrist of one arm while finger sensor 220 measures the heartbeat in a finger of the hand of the other arm. This combination allows the sensors, which in one embodiment are conductive, to measure an electrical potential through the body. Information about the electrical potential provides cardiac information (e.g., HRV, fatigue level, heart rate information, and so on), and such information may be processed to determine the HRV. In other embodiments, the HRV is measured using sensors that monitor other parts of the user's body rather than the finger and wrist. For example, the sensors may monitor the ankle, leg, arm, or torso.

In various embodiments, at least one of the operations of anticipating the activity, providing encouragement, providing the notification, and providing the set of target goals includes using a sensor configured to be attached to the body of the user.

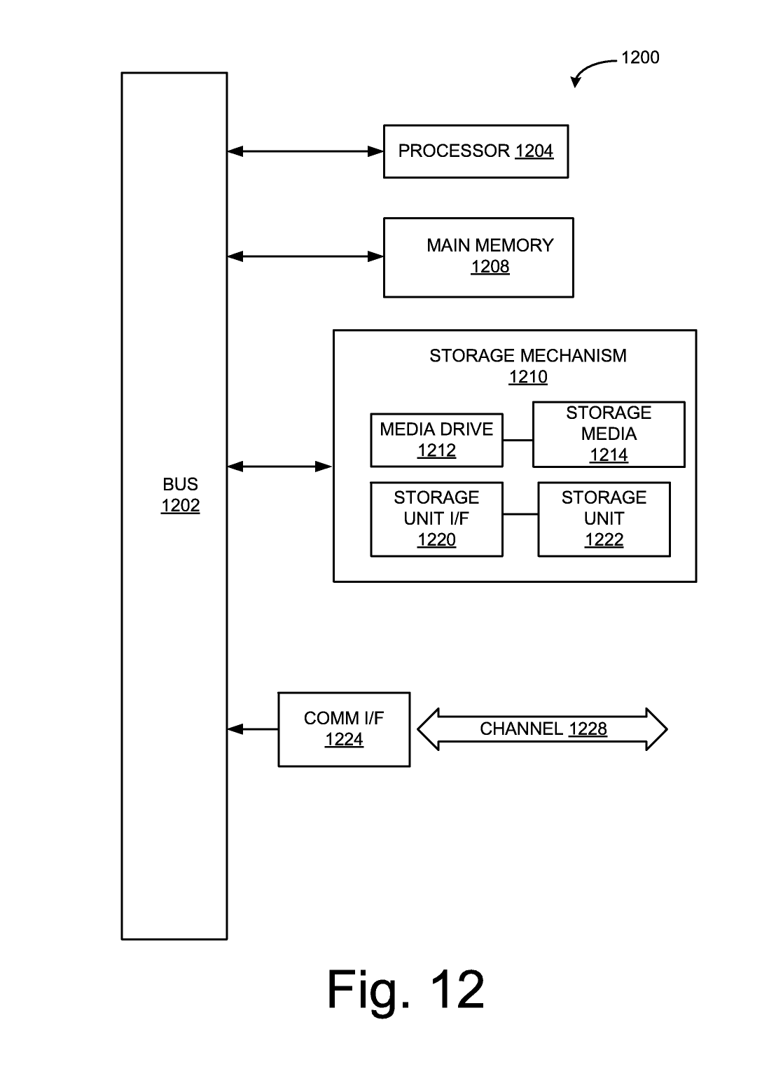

FIG. 12 illustrates an example computing module that may be used to implement various features of the systems and methods disclosed herein. In one embodiment, the computing module includes a processor and a set of computer programs residing on the processor. The set of computer programs is stored on a non-transitory computer readable medium having computer executable program code embodied thereon. The computer executable code is configured to anticipate an activity based on an archive. The archive includes historical information associated with past activity. The computer executable code is further configured to provide encouragement for the activity, wherein the encouragement is based on the archive and the activity.

The example computing module may be used to implement these various features in a variety of ways, as described above with reference to the example methods illustrated in FIGS. 10A, 10B, and 11 and as will be appreciated by one of ordinary skill in the art.

As used herein, the term module might describe a given unit of functionality that can be performed in accordance with one or more embodiments of the present application. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the application are implemented in whole or in part using software, in one embodiment, these software elements can be implemented to operate with a computing or processing module capable of carrying out the functionality described with respect thereto. One such example computing module is shown in FIG. 12. Various embodiments are described in terms of this example-computing module 1200. After reading this description, it will become apparent to a person skilled in the relevant art how to implement the application using other computing modules or architectures.

Referring now to FIG. 12, computing module 1200 may represent, for example, computing or processing capabilities found within desktop, laptop, notebook, and tablet computers; hand-held computing devices (tablets, PDA's, smart phones, cell phones, palmtops, smart-watches, smart-glasses etc.); mainframes, supercomputers, workstations or servers; or any other type of special-purpose or general-purpose computing devices as may be desirable or appropriate for a given application or environment. Computing module 1200 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 1200 might include, for example, one or more processors, controllers, control modules, or other processing devices, such as a processor 1204. Processor 1204 might be implemented using a general-purpose or special-purpose processing engine such as, for example, a microprocessor, controller, or other control logic. In the illustrated example, processor 1204 is connected to a bus 1202, although any communication medium can be used to facilitate interaction with other components of computing module 1200 or to communicate externally.

Computing module 1200 might also include one or more memory modules, simply referred to herein as main memory 1208. For example, preferably random access memory (RAM) or other dynamic memory, might be used for storing information and instructions to be executed by processor 1204. Main memory 1208 might also be used for storing temporary variables or other intermediate information during execution of instructions to be executed by processor 1204. Computing module 1200 might likewise include a read only memory (“ROM”) or other static storage device coupled to bus 1202 for storing static information and instructions for processor 1204.

The computing module 1200 might also include one or more various forms of information storage mechanism 1210, which might include, for example, a media drive 1212 and a storage unit interface 1220. The media drive 1212 might include a drive or other mechanism to support fixed or removable storage media 1214. For example, a hard disk drive, a solid state drive, a magnetic tape drive, an optical disk drive, a CD or DVD drive (R or RW), or other removable or fixed media drive might be provided. Accordingly, storage media 1214 might include, for example, a hard disk, a solid state drive, magnetic tape, cartridge, optical disk, a CD or DVD, or other fixed or removable medium that is read by, written to or accessed by media drive 1212. As these examples illustrate, the storage media 1214 can include a computer usable storage medium having stored therein computer software or data.

In alternative embodiments, information storage mechanism 1210 might include other similar instrumentalities for allowing computer programs or other instructions or data to be loaded into computing module 1200. Such instrumentalities might include, for example, a fixed or removable storage unit 1222 and a storage interface 1220. Examples of such storage units 1222 and storage interfaces 1220 can include a program cartridge and cartridge interface, a removable memory (for example, a flash memory or other removable memory module) and memory slot, a PCMCIA slot and card, and other fixed or removable storage units 1222 and storage interfaces 1220 that allow software and data to be transferred from the storage unit 1222 to computing module 1200.

Computing module 1200 might also include communications interface 1224. Communications interface 1224 might be used to allow software and data to be transferred between computing module 1200 and external devices. Examples of communications interface 1224 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 1224 might typically be carried on signals, which can be electronic, electromagnetic (which includes optical) or other signals capable of being exchanged by a given communications interface 1224. These signals might be provided to communications interface 1224 via a channel 1228. This channel 1228 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media such as, for example, memory 1208, storage unit 1220, media 1214, and channel 1228. These and other various forms of computer program media or computer usable media may be involved in carrying one or more sequences of one or more instructions to a processing device for execution. Such instructions embodied on the medium are generally referred to as “computer program code” or a “computer program product” (which may be grouped in the form of computer programs or other groupings). When executed, such instructions might enable computing module 1200 to perform features or functions of the present application as discussed herein.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of example block diagrams, flow charts, and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

While various embodiments of the present disclosure have been described above, it should be understood that these embodiments have been presented by way of example only, and not of limitation. Likewise, the various diagrams may depict an example architectural or other configuration for the disclosure, which is done to aid in understanding the features and functionality that can be included in the disclosure. The disclosure is not restricted to the illustrated example architectures or configurations, but the desired features can be implemented using a variety of alternative architectures and configurations. Indeed, it will be apparent to one of skill in the art how alternative functional, logical, or physical partitioning and configurations can be implemented to implement the desired features of the present disclosure. Also, a multitude of different constituent module names other than those depicted herein can be applied to the various partitions. Additionally, with regard to flow diagrams, operational descriptions, and method claims, the order in which the steps are presented herein does not mandate that various embodiments be implemented to perform the recited functionality in the same order, unless the context dictates otherwise.

Although the disclosure is described above in terms of various example embodiments and implementations, it should be understood that the various features, aspects, and functionalities described in one or more of the individual embodiments are not limited in their applicability to the particular embodiment with which they are described, but instead can be applied, alone or in various combinations, to one or more of the other embodiments of the disclosure, whether or not such embodiments are described and whether or not such features are presented as being a part of a described embodiment. Thus, the breadth and scope of the present disclosure should not be limited by any of the above-described example embodiments.

What is claimed is:

1. An apparatus for anticipating activity, comprising:
an activity anticipation module that anticipates an activity based on an archive, the archive comprising historical information associated with past activity; and
an encouragement module that provides encouragement for the activity, wherein the encouragement is based on the archive and the activity.

2. The apparatus of claim 1, further comprising a notification module that provides a notification associated with the activity.

3. The apparatus of claim 2, wherein the notification module provides the notification via social media.

4. The apparatus of claim 2, wherein the notification module provides the notification to an electronic device.

5. The apparatus of claim 1, wherein the encouragement comprises media content.

6. The apparatus of claim 5, wherein the media content is selected based on the archive indicating an association between the media content and the activity.

7. The apparatus of claim 1, further comprising a target goal module that provides a set of target goals for the activity, wherein each target goal is based on the archive and the activity.

8. The apparatus of claim 8, wherein the set of target goals comprises at least one of a target activity type, a target activity intensity, and a target activity duration.

9. The apparatus of claim 1, wherein at least one of the activity anticipation module and the encouragement module is embodied in a wearable sensor.

10. A method for anticipating activity, comprising:
anticipating an activity based on an archive, the archive comprising historical information associated with past activity; and
providing encouragement for the activity, wherein the encouragement is based on the archive and the activity.

11. The method of claim 10, further comprising providing a notification associated with the activity.

12. The method of claim 11, wherein the notification is provided via social media.

13. The method of claim 11, wherein the notification is delivered to an electronic device.

14. The method of claim 10, wherein the encouragement comprises media content.

15. The method of claim 14, wherein the media content comprises a set of songs.

16. The method of claim 14, wherein the media content is selected based on the archive indicating an association between the media content and the activity.

17. The method of claim 10, further comprising providing a set of target goals for the activity, wherein each target goal is based on the archive and the activity.

18. The method of claim 17, wherein the set of target goals comprises at least one of a target activity type, a target activity intensity, and a target activity duration.

19. The method of claim 10, wherein at least one of the operations of anticipating the activity and providing encouragement for the activity comprises using a sensor configured to be attached to the body of a user.

20. A system for providing a sleep recommendation, comprising:
a processor; and
at least one computer program residing on the processor;
wherein the computer program is stored on a non-transitory computer readable medium having computer executable program code embodied thereon, the computer executable program code configured to:
anticipate an activity based on an archive, the archive comprising historical information associated with past activity; and
provide encouragement for the activity, wherein the encouragement is based on the archive and the activity.
